(19) United States
(12) Patent Application Publication
(10) Pub. No.: US 2025/0072679 A1
(43) Pub. Date: Mar. 6, 2025

(54) Suction Head Provided With A Brush Motor Cooling Circuit

(71) Applicant: SEB S.A., Ecully (FR)

(72) Inventors: Antoine Marti, Ecully Cedex (FR); Xavier Baert, Ecully Cedex (FR); Thomas Guillard, Ecully Cedex (FR)

(73) Assignee: SEB S.A., Ecully (FR)

(21) Appl. No.: 18/826,726

(22) Filed: Sep. 6, 2024

(30) Foreign Application Priority Data
Sep. 6, 2023 (FR) 23/09352

(51) Int. Cl. A47L 9/04; H02K 9/10

(52) U.S. Cl. CPC A47L 9/0411; A47L 9/0455; A47L 9/0477; H02K 9/10

(57) ABSTRACT

The suction head comprises a main body (4); a rotating brush (11) comprising a brush body (12); a motor compartment (19) housed in a motor housing (21) delimited by the brush body (12); a drive motor (17) housed in the motor compartment (19) and configured to drive in rotation the brush body (12) about an axis of rotation; and an air-cooling circuit (41) fluidly connected to the suction chamber (9) and including a first circuit portion (41.1) partially delimited by the drive motor (17) and a second circuit portion (41.2) partially delimited by the motor compartment (19) and the brush body (12) and located downstream of the first circuit portion (41.1).

### TECHNICAL FIELD

The present invention relates to the field of vacuum cleaners equipped with a suction head allowing sucking up dust and waste present on a surface to be cleaned.

### PRIOR ART

Vacuum cleaners equipped with a suction head are well known on the market, as they allow cleaning surfaces by suction to remove dust and waste resting on them. The surface to be vacuumed can, for example, be tiles, parquet, laminate, carpet or a rug.

A suction head comprises, in a known manner, a main body including a soleplate provided with a lower face and a suction mouth opening into the lower face of the soleplate. The lower face of the soleplate is intended to be positioned adjacent to the surface to be vacuumed during use of the suction head.

In order to improve the cleaning performance of a suction head, it is known to equip the latter with:
a rotating brush comprising a brush body which is movable in rotation about an axis of rotation and which is mounted, for example removably, in a suction chamber delimited by the main body of the suction head, the brush body including a first end portion delimiting a motor housing, and a second end portion located opposite the first end portion,
a first support ring fastened to the first end portion of the brush body and configured to support said first end portion, and a second support ring fastened to the second end portion of the brush body and configured to support said second end portion,
a first bearing, such as a rolling bearing, configured to guide in rotation the first support ring, and a second bearing, such as a rolling bearing, configured to guide in rotation the second support ring, and
a drive device configured to drive in rotation the brush body about the axis of rotation, the drive device comprising a drive motor arranged in the motor housing delimited by the first end portion of the brush body.

During the operation of such a suction head where the rotating brush is rotated, the drive motor tends to heat up due to its location in the brush body, which can harm the operation of the drive motor and therefore the reliability of the suction head.

In order to limit the heating of the drive motor, it is known to equip the suction head with an air-cooling circuit fluidly connected to the suction chamber, and to configure the suction head so that, when a vacuum is generated in the suction chamber, air is sucked up into the air-cooling circuit from the outside of the rotating brush and is circulated in the air-cooling circuit.

EP2811883 describes in particular an air-cooling circuit including a first circuit portion which is partially delimited by the motor compartment and the brush body, and a second circuit portion which is partially delimited by the drive motor and which is located downstream of the first circuit portion, the air-cooling circuit being configured so that, when a vacuum is generated in the suction chamber, the air, circulated in the first circuit portion, flows at least partially between the motor compartment and the brush body, and so that, the air, circulated in the second circuit portion, flows at least partially inside the drive motor.

Although such an air-cooling circuit ensures cooling of the drive motor, this cooling may not be sufficient in some use configurations of the suction head.

### SUMMARY OF THE INVENTION

The present invention aims to remedy all or part of these drawbacks.

The technical problem underlying the invention consists in particular in providing a suction head, provided with a rotating brush and a brush drive motor housed in the rotating brush, which is simple and economical in structure, while ensuring satisfactory cooling of the brush drive motor.

To this end, the present invention relates to a suction head comprising:
a main body including a suction chamber opening into a lower face of the main body which is configured to be oriented towards a surface to be cleaned,
a rotating brush comprising a brush body which has a generally tubular shape and which has a central longitudinal axis, the brush body being movably mounted in rotation in the suction chamber about an axis of rotation which is substantially coaxial with the central longitudinal axis of the brush body,
a drive device configured to drive in rotation the brush body about the axis of rotation, the drive device including a drive motor,
a motor compartment which is fixed relative to the main body and in which the drive motor is at least partially arranged, the motor compartment and the drive motor being at least partially arranged in a motor housing delimited by the brush body, and
an air-cooling circuit fluidly connected to the suction chamber, the suction head being configured so that, when a vacuum is generated in the suction chamber, air is sucked up in the air-cooling circuit from the outside of the rotating brush and is circulated in the air-cooling circuit.

The air-cooling circuit includes a first circuit portion which is partially delimited by the drive motor and a second circuit portion which is partially delimited by the motor compartment and the brush body and which is located downstream of the first circuit portion, and the air-cooling circuit is configured so that, when a vacuum is generated in the suction chamber, the air, circulated in the first circuit portion, flows at least partially inside the drive motor, and so that, the air, circulated in the second circuit portion, flows at least partially between the motor compartment and the brush body.

Under conditions of use, the drive motor has a temperature much higher than that of the motor compartment. Thus, the fact that the air, circulating in the air-cooling circuit, flows first inside the drive motor then along an outer surface of the motor compartment allows limiting the heating of the air stream circulating in the first circuit portion before it enters the drive motor and therefore ensuring an optimized heat exchange between the drive motor and the air stream (due to a significant temperature difference). Such an optimized heat exchange ensures optimized cooling of the drive motor.

The suction head may also have one or several of the following features, taken alone or in combination.

According to one embodiment of the invention, the drive motor includes a motor casing. The drive motor further includes a rotor and a stator which are housed in the motor casing.

According to one embodiment of the invention, the drive motor is arranged entirely in the motor compartment.

According to one embodiment of the invention, the first circuit portion is configured so that, when a vacuum is generated in the suction chamber, the air, flowing inside the drive motor, flows in a flow direction which is substantially parallel to the central longitudinal axis of the brush body.

According to one embodiment of the invention, the air-cooling circuit is configured so that, when a vacuum is generated in the suction chamber, the air, circulated in the first circuit portion, flows in contact with the rotor and/or the stator of the drive motor, and for example in contact with the stator winding and/or the rotor winding.

According to one embodiment of the invention, the air-cooling circuit is configured so that, when a vacuum is generated in the suction chamber, the air, circulated in the second circuit portion, flows substantially parallel to the central longitudinal axis of the brush body.

According to one embodiment of the invention, the first circuit portion includes at least one air inlet opening provided on a peripheral wall of a motor casing of the drive motor and through which the air, circulated in the air-cooling circuit when a vacuum is generated in the suction chamber, is capable of entering the drive motor, and at least one air outlet opening provided on a end wall of the motor casing and through which the air, having entered the drive motor via the at least one air inlet opening, is capable of flowing outside the drive motor.

According to one embodiment of the invention, the at least one air inlet opening, provided on the motor casing, is oriented substantially radially and the at least one air outlet opening, provided on the motor casing, is oriented substantially axially.

According to one embodiment of the invention, the brush body includes a first end portion delimiting the motor housing and a second end portion located opposite the first end portion, and the suction head includes a first brush support, such as a first brush support ring, fastened to the first end portion of the brush body and configured to support said first end portion and a second brush support, such as a second brush support ring, fastened to the second end portion of the brush body and configured to support said second end portion. Such a configuration of the suction head ensures optimized rotational guidance of the rotating brush, which significantly limits the generation of vibrations within the suction head and the risks of seizure of the rotating brush.

According to one embodiment of the invention, the motor compartment and the brush body delimit a connecting chamber which is located axially opposite the first brush support relative to the drive motor and which is configured to fluidly connect the first circuit portion to the second circuit portion. Advantageously, the at least one air outlet opening is fluidly connected to the connecting chamber.

According to one embodiment of the invention, the drive motor is arranged axially between the first and second brush supports.

According to one embodiment of the invention, the drive motor is closer to the first brush support than to the second brush support. Advantageously, the drive motor is arranged axially between the first brush support and a median vertical plane of the suction head. Hence the need to cool the first brush support which heats up more quickly than the second brush support because of its proximity to the drive motor.

According to one embodiment of the invention, the air-cooling circuit is configured so that, when a vacuum is generated in the suction chamber, the air, circulated in the air-cooling circuit, flows in the first circuit portion away from the first brush support, and flows in the second circuit portion towards the first brush support.

According to one embodiment of the invention, the suction head includes a first bearing, such as a rolling bearing and for example a ball bearing, configured to guide in rotation the first brush support and a second bearing, such as a rolling bearing and for example a ball bearing, configured to guide in rotation the second brush support, the first brush support being interposed between the first bearing and an inner circumferential surface of the brush body.

According to one embodiment of the invention, the suction head includes a bearing support which is fixed relative to the main body, the first bearing being mounted on the bearing support and supported by the bearing support.

According to one embodiment of the invention, the first bearing is a rolling bearing, and includes an inner ring which is fastened to the bearing support and which extends around the bearing support, and an outer ring which is fastened to the first brush support, the first brush support extending around the outer ring of the bearing.

According to one embodiment of the invention, the bearing support, the first bearing and the first brush support are arranged substantially coaxially with the central longitudinal axis of the brush body.

According to one embodiment of the invention, the motor compartment is fastened to the bearing support.

According to one embodiment of the invention, the motor compartment includes a motor cover extending around the drive motor and a cover support fastened to the bearing support and configured to support the motor cover. According to one embodiment of the invention, the motor cover includes an open end, and the cover support at least partially closes the open end of the motor cover.

According to one embodiment of the invention, the motor cover includes a tubular wall which extends around the drive motor and which is substantially coaxial with the motor axis of the drive motor, and an end wall located opposite the cover support and provided with a central opening through which the output shaft of the drive motor projects.

According to one embodiment of the invention, the suction head includes a damping element interposed axially between the drive motor and the cover support.

According to one embodiment of the invention, the bearing support delimits an air flow duct which partially forms the first circuit portion, the bearing extending around the air flow duct. Such a configuration of the bearing support ensures cooling, by heat conduction, of the bearing support and the first bearing, and in particular of the outer ring of the first bearing. Advantageously, the air flow duct is fluidly connected to the at least one air intake opening.

According to one embodiment of the invention, the air flow duct extends substantially coaxially with the first bearing.

According to one embodiment of the invention, the air-cooling circuit is delimited at least partially by the first brush support. Such a configuration of the air-cooling circuit ensures cooling, by heat conduction, of the first brush support and the first bearing located near the drive motor, and in particular of the outer ring of the first bearing, due to the fact that the air circulating in the air-cooling circuit flows near the first brush support.

According to one embodiment of the invention, the first brush support is annular and includes at least one through hole which opens respectively into a first axial face of the first brush support which is oriented towards the drive motor and into a second axial face of the first brush support which is opposite to the respective first axial face, the at least one through hole being fluidly connected to the suction chamber and the suction head being configured so that, when a vacuum is generated in the suction chamber, an air stream flows through the at least one through hole and from the first axial face of the first brush support towards the second axial face of the first brush support. Such a configuration of the first brush support, and in particular the presence of the at least one through hole, ensures, when a vacuum is generated in the suction chamber, flowing of an air stream through the at least one through hole, and therefore cooling, by heat conduction, of the first brush support and the first bearing located near the drive motor. Such a cooling allows limiting the heating of the first bearing and thus preserving its integrity, and therefore conferring increased reliability on the suction head according to the present invention, and also being able to use a first bearing of smaller dimensions and thus reducing the radial size of the rotating brush.

According to one embodiment of the invention, the at least one through hole opens into the motor housing.

According to one embodiment of the invention, the first brush support includes an inner wall which is generally cylindrical and which extends around and in contact with the first bearing, the inner wall of the first brush support including at least one radial through opening, extending in a radial direction, opening into the at least one through hole provided on the first brush support and being located facing the first bearing. Such a configuration of the first brush support allows further promoting the cooling of the first bearing, and in particular of its outer ring, by the air stream flowing through the at least one through hole.

According to one embodiment of the invention, the inner wall of the first brush support includes a plurality of radial through openings distributed about the central axis of the first brush support, each radial through opening opening into a respective through hole provided on the first brush support and being located facing the first bearing, and for example facing the outer ring of the first bearing.

According to one embodiment of the invention, the air-cooling circuit includes at least one air discharge opening through which the air flowing into the air-cooling circuit is capable of being discharged out of the air-cooling circuit, the at least one air discharge opening being formed by the at least one through hole provided on the first brush support. Thus, the suction head is configured so that the air sucked up into the air-cooling circuit is discharged out of the air-cooling circuit via the at least one through hole provided on the first brush support.

According to one embodiment of the invention, the at least one through hole provided on the first brush support is delimited at least partially by at least one stream guide wall which is inclined relative to a central axis of the first brush support and which is configured to generate a vacuum within the at least one through hole when the drive motor is running and drives in rotation the rotating brush. Such a configuration of the first brush support increases the air flow rate in the air-cooling circuit, and therefore further promotes the cooling of the drive motor and the first bearing.

According to one embodiment of the invention, the at least one stream guide wall forms a stream guide fin, also called a blade.

According to one embodiment of the invention, the at least one stream guide wall has an axial dimension and a radial dimension which is smaller than the respective axial dimension.

According to one embodiment of the invention, the at least one through hole provided on the first brush support is delimited at least partially by two stream guide walls which are inclined relative to the central axis of the first brush support and which are located facing each other, the two stream guide walls delimiting at least partially the at least one through hole being configured to generate a vacuum within the at least one through hole when the drive motor is running and drives in rotation the rotating brush.

According to one embodiment of the invention, the first brush support forms an impeller provided with stream guide fins distributed about a central axis of the first brush support, each pair of adjacent stream guide fins partially delimiting a respective through hole, and the first brush support, forming the impeller, is configured to generate a vacuum within the at least one through hole when the drive motor is running and drives in rotation the rotating brush. Thus, when the brush body is driven in rotation, the first brush support, forming an impeller and secured in rotation to the brush body, is also driven in rotation so that the impeller can suck up the air from the first axial face of the first brush support towards the second axial face of the first brush support. In other words, the first brush support forming an impeller allows, when it is driven in rotation by the rotation of the rotating brush, forcing a flow of air from the inside of the rotating brush towards the outside of the rotating brush.

According to one embodiment of the invention, each stream guide fin has an axial dimension and a radial dimension which is smaller than the respective axial dimension. Such a configuration of the first brush support allows optimizing the radial size of the first brush support, and thus either reducing the radial size of the rotating brush, or increasing the radial dimensions of the first bearing and therefore increasing its service life.

According to one embodiment of the invention, the air-cooling circuit includes at least one air intake opening through which air is capable of being sucked up into the air-cooling circuit, the at least one air intake opening being provided on a lateral wall of the main body, and for example on a lateral wall of the main body located on the side of the bearing support and advantageously to which the bearing support is fastened.

According to one embodiment of the invention, the at least one air intake opening is oriented substantially axially, that is to say substantially parallel to the central longitudinal axis of the brush body. Such an orientation of the at least one air intake opening limits the risks of dust being sucked up by the air-cooling circuit, which allows significantly reducing the risks of dirt collection or even clogging, of the air-cooling circuit and therefore ensuring optimal cooling of the drive motor and also of the first bearing when the air-cooling circuit is partially delimited by the first brush support.

According to one embodiment of the invention, the motor compartment delimits an inner housing which is fluidly connected to the at least one air intake opening belonging to the air-cooling circuit.

According to one embodiment of the invention, the at least one air inlet opening, provided on the motor casing, opens into the inner housing delimited by the motor compartment.

According to one embodiment of the invention, the at least one air intake opening is substantially coaxial with the central longitudinal axis of the brush body.

According to one embodiment of the invention, the drive motor is located remotely from the lateral walls of the main body. Such an arrangement of the drive motor ensures better balancing of masses within the main body, and in particular about the central longitudinal axis.

According to one embodiment of the invention, the first brush support includes a plurality of through holes distributed about the central axis of the first brush support, each through hole opening respectively into the first and second axial faces of the first brush support and being configured to enable the passage of an air stream through said through hole.

According to one embodiment of the invention, the suction head includes a fastening device configured to fasten the first bearing to the first brush support.

According to one embodiment of the invention, the fastening device includes at least one fastening tab which is elastically deformable and which is provided on the first brush support, the at least one fastening tab being configured to cooperate with the first bearing, and more particularly with the outer ring of the first bearing, so as to fasten the first bearing to the first brush support.

According to one embodiment of the invention, the at least one fastening tab extends substantially parallel to the central axis of the first brush support.

According to one embodiment of the invention, the first brush support includes at least one stop member, such as a stop rib, provided with an axial stop surface against which the first bearing abuts when the first bearing is fastened to the first brush support.

According to one embodiment of the invention, the first brush support includes a bearing housing in which the first bearing is received.

According to one embodiment of the invention, the at least one fastening tab includes a retaining portion configured to retain the first bearing in the bearing housing.

According to one embodiment of the invention, the at least one fastening tab is configured to axially immobilize the first bearing relative to the first brush support.

According to one embodiment of the invention, the fastening device includes a plurality of fastening tabs distributed about the central axis of the first brush support.

According to one embodiment of the invention, the rotating brush further comprises coupling means arranged in the brush body and configured to couple in rotation with complementary coupling means which belong to the drive device and which are rotatably coupled to the output shaft of the drive motor.

According to one embodiment of the invention, the brush body is configured to be removably mounted in the suction chamber, for example in a mounting direction which extends substantially perpendicular to a direction of movement of the suction head.

According to one embodiment of the invention, the main body includes a passage opening opening into the suction chamber and through which the brush body is capable of being introduced into and removed from the suction chamber, the suction head comprising a closure cap which is configured to at least partially close the passage opening, the brush body being rotatably mounted relative to the closure cap.

According to the embodiment of the invention, the passage opening is provided on a lateral wall of the main body.

According to one embodiment of the invention, the second brush support is movably mounted in rotation relative to the closure cap.

According to one embodiment of the invention, the rotating brush includes bristles provided on the outer surface of the brush body. Advantageously, the rotating brush includes at least one row of bristles provided on the outer surface of the brush body.

According to one embodiment of the invention, the main body comprises a soleplate provided with the lower face which is configured to be oriented towards the surface to be cleaned, and with a suction mouth opening into the lower face. Advantageously, the suction chamber opens into the lower face of the soleplate via the suction mouth.

According to one embodiment of the invention, the suction mouth has an elongated shape and extends substantially perpendicular to the direction of movement of the suction head.

### BRIEF DESCRIPTION OF THE FIGURES

In any case, the invention will be clearly understood using the following description with reference to the appended schematic drawings representing, as a non-limiting example, an embodiment of this suction head.

FIG. 1 is a top perspective view of a suction head according to the present invention.

FIG. 2 is a top perspective view of the suction head of FIG. 1 showing a rotating brush of the partially removed suction head.

FIG. 3 is a top perspective view of the suction head of FIG. 1.

FIG. 4 is a longitudinal sectional view of the suction head of FIG. 1.

FIG. 5 is a longitudinal sectional view of the suction head of FIG. 1 showing the rotating brush of the partially removed suction head.

FIG. 6 is a view, on an enlarged scale, of a detail of FIG. 4.

FIG. 7 is a perspective view of a subassembly, belonging to the suction head of FIG. 1, comprising a drive device, a cover support, a bearing, a bearing support and a brush support.

FIG. 8 is a perspective view of a brush support belonging to the suction head of FIG. 1.

FIG. 9 is a truncated perspective view of the brush support of FIG. 8.

FIG. 10 is a longitudinal sectional view of the suction head of FIG. 1 in which the left and right portions of the suction head have been cut along two longitudinal section planes offset with respect to each other.

### DETAILED DESCRIPTION

Unless otherwise stated, the term “substantially” means, in the present document, “exactly or within 10% or within 10°”.

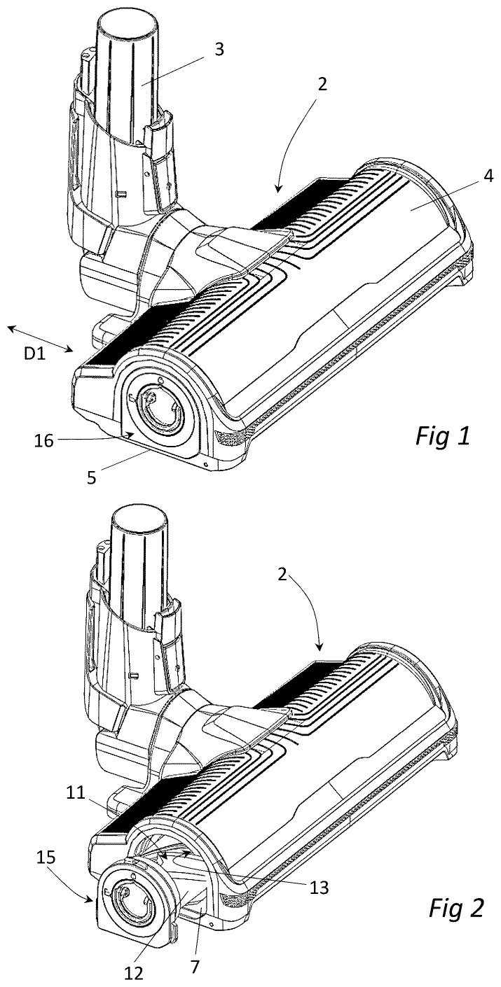

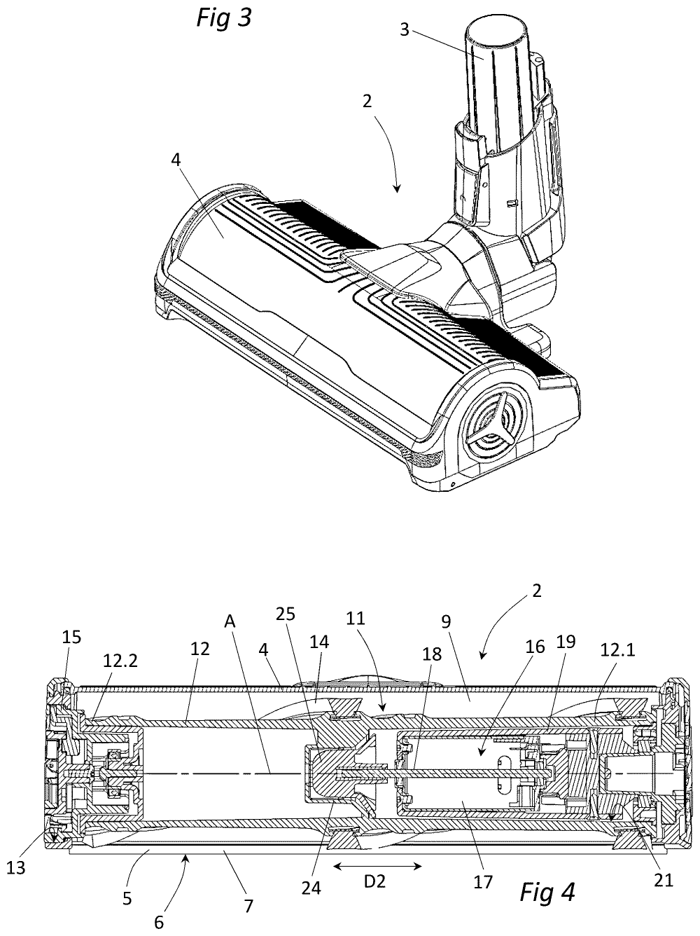

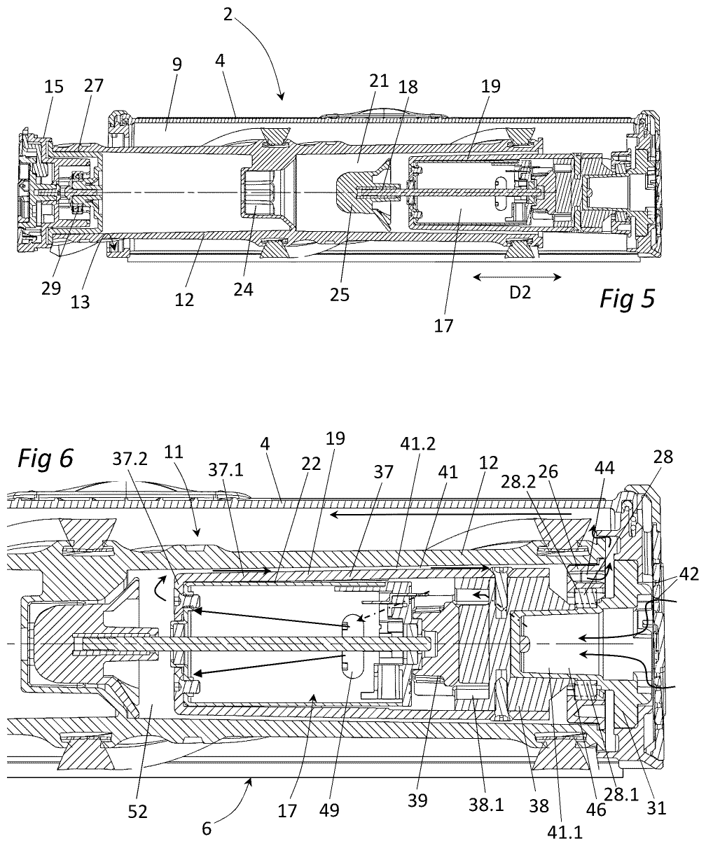

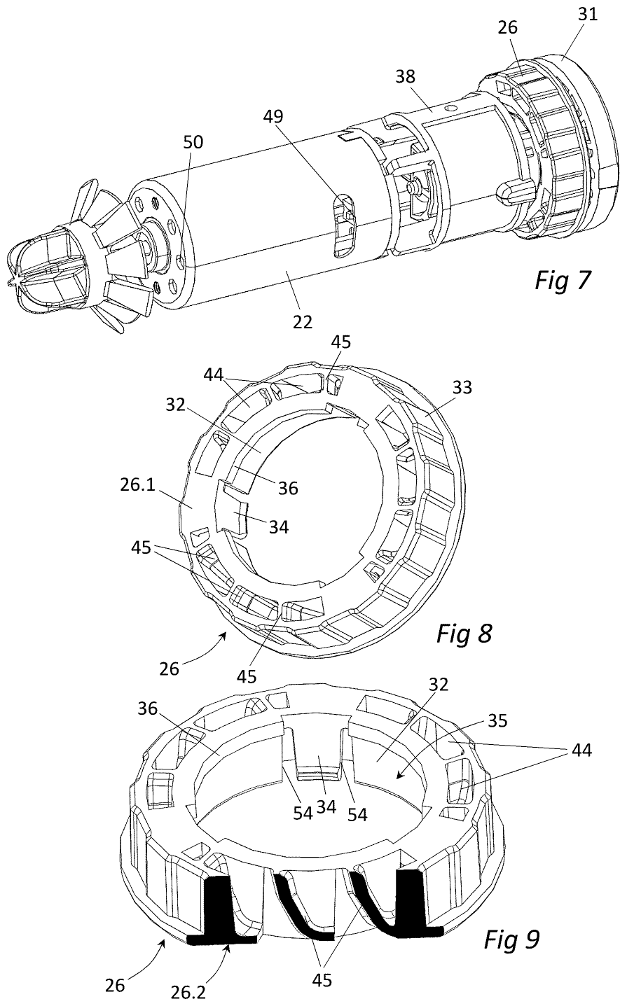

FIGS. 1 to 10 represent a suction head 2 comprising a connection sleeve 3 to which a tip of a rigid or flexible tube is intended to be connected, itself connected to a suction system of a vacuum cleaner (not illustrated). Various variants of vacuum cleaners already exist on the market and may be used with the suction head 2 according to the invention; these variants being known to those skilled in the art, they are not detailed in the present patent application.

The suction head 2 comprises a main body 4 configured to be moved over a surface to be cleaned. The connection sleeve 3 is advantageously mounted with a pivot link relative to the main body 4 so as to enable pivoting of the connection sleeve 3, relative to the main body 4, forwards and backwards during movement of the suction head 2 in a direction of movement D1.

The main body 4 comprises a soleplate 5 provided with a lower face 6 configured to be oriented towards the surface to be cleaned, and with a suction mouth 7 opening onto the lower face 6. The suction mouth 7 communicates with the connection sleeve 3 in particular by means of a suction duct formed at least partially for example by a flexible connecting duct. The suction mouth 7 can for example have an elongated shape and extend transversely, and for example perpendicularly, to the direction of movement D1 of the suction head 2.

The main body 4 further comprises a suction chamber 9 which opens into the lower face 6 of the soleplate 5 via the suction mouth 7, and which is fluidly connected to the suction duct.

The suction head 2 also comprises a rotating brush 11 comprising a brush body 12 which has a generally tubular shape and which has a central longitudinal axis A. The brush body 12 is movably mounted in rotation in the suction chamber 9 about an axis of rotation which is coaxial with the central longitudinal axis A of the brush body 12.

Advantageously, the brush body 12 is removably mounted in the suction chamber 9 and is configured to be introduced into and removed from the suction chamber 9 in a mounting direction D2. The mounting direction D2 extends transversely, and preferably perpendicularly, to the direction of movement DI of the suction head 2.

According to the embodiment represented in the figures, the main body 4 includes a passage opening 13 opening into the suction chamber 9 and through which the brush body 12 can be introduced into and removed from the suction chamber 9. Advantageously, the passage opening 13 is provided on a lateral wall of the main body 4.

According to the embodiment represented in the figures, the rotating brush 11 includes bristles 14 provided on the outer surface of the brush body 12. Advantageously, the brush body 12 is generally cylindrical with a circular cross-section, and the rotating brush 11 includes a plurality of rows of bristles extending for example helically about the central longitudinal axis A of the brush body 12. According to a variant not represented in the figures, the rows of bristles could be replaced by elastically deformable lamellae or by a foam cleaning sleeve. According to another variant not represented in the figures, the rotating brush 11 could include at least one row of bristles and at least one elastically deformable lamella.

The suction head 2 further includes a closure cap 15 which is configured to at least partially close the passage opening 13 when the brush body 12 is mounted in the suction chamber 9.

The suction head 2 also includes a drive device 16 configured to drive in rotation the brush body 12 about the axis of rotation. The drive device 16 more particularly comprises a preferably electric drive motor 17, comprising an output shaft 18 which is coaxial with the axis of rotation of the brush body 12.

The drive motor 17 is housed in a motor compartment 19 fastened to a lateral wall of the main body 4, and the motor compartment 19 and the drive motor 17 are arranged in a motor housing 21 delimited by the brush body 12. In a known manner, the drive motor 17 includes a motor casing 22, and also a rotor and a stator (not represented in the figures) which are housed in the motor casing 22. Advantageously, the drive motor 17 is located remotely from the lateral walls of the main body 4. Advantageously, the drive motor 17 is off-center relative to a median vertical plane of the main body 4 and is arranged between the median vertical plane of the main body 4 and one of the two lateral walls.

According to the embodiment represented in the figures, the brush body 12 includes a first end portion 12.1 which is located near the drive device 16 and which delimits the motor housing 21, and a second end portion 12.2 which is supported by the closure cap 15 and which is movably mounted in rotation relative to the closure cap 15.

The rotating brush 11 further includes a coupling part 24 which is arranged in the brush body 12 and which is configured to couple in rotation with a complementary coupling part 25 which belongs to the drive device 16 and which is coupled in rotation to the output shaft 18 of the drive motor 17. According to the embodiment represented in the figures, the coupling part 24 is a female coupling part and the complementary coupling part 25 is a male coupling part. However, according to a variant of the invention, the coupling part 24 could be a male coupling part and the complementary coupling part 25 could be a female coupling part.

The suction head 2 also includes a first brush support 26, such as a first brush support ring, which is fastened to the first end portion 12.1 of the brush body 12 and which is configured to support the first end portion 12.1, and a second brush support 27, such as a second brush support ring, which is fastened, for example by gluing or welding, to the second end portion 12.2 of the brush body 12 and which is configured to support the second end portion 12.2. Advantageously, the first brush support 26 and the second brush support 27 are annular and are arranged coaxially with the central longitudinal axis A of the brush body 12, and the drive motor 17 is arranged axially between the first brush support 26 and the second brush support 27.

According to the embodiment represented in the figures, the drive motor 17 is closer to the first brush support 26 than to the second brush support 27. Advantageously, the drive motor 17 is arranged axially between the first brush support 26 and the median vertical plane of the brush body 12.

The suction head 2 further includes a first bearing 28, such as a rolling bearing and for example a ball bearing, configured to guide in rotation the first brush support 26, and a second bearing 29, such as a rolling bearing and for example a ball bearing, configured to guide in rotation the second brush support 27. Advantageously, the second bearing 29 is interposed between the second brush support 27 and a support part belonging to the closure cap 15.

According to the embodiment represented in the figures, the suction head 2 includes a bearing support 31 which is fastened to a lateral wall of the main body 4 and which is coaxial with the central longitudinal axis A, and the first bearing 28 is mounted on the bearing support 31 and is supported by the bearing support 31.

The first bearing 28 more particularly includes an inner ring 28.1 which is fastened to the bearing support 31 and which extends around the bearing support 31, and an outer ring 28.2 which is movable in rotation relative to the inner ring 28.1 and which is fastened to the first brush support 26. Advantageously, the first brush support 26 is arranged in the first end portion 12.1 of the brush body 12, and is interposed between the outer ring 28.2 of the first bearing 28 and an inner circumferential surface of the brush body 12.

As shown more particularly in FIG. 8, the first brush support 26 includes an inner wall 32 which is generally cylindrical and which extends around and in contact with the outer ring 28.2 of the first bearing 28, and an outer wall 33 which is generally cylindrical and which cooperates with the inner circumferential surface of the brush body 12.

The suction head 2 advantageously includes a fastening device configured to fasten the first bearing 28 to the first brush support 26. According to the embodiment represented in the figures, the fastening device includes a plurality of fastening tabs 34 which are provided on the first brush support 26, which are distributed about the central axis of the first brush support 26 and which extend substantially parallel to the central axis of the first brush support 26. The fastening tabs 34 are configured to cooperate with the first bearing 28, and more particularly with the outer ring 28.2 of the first bearing 28, so as to fasten the first bearing 28 to the first brush support 26 and in particular so as to axially immobilize the first bearing 28 relative to the first brush support 26. Advantageously, the first brush support 26 includes a bearing housing 35 in which the first bearing 28 is received, and each fastening tab 34 is elastically deformable and includes a retaining portion configured to retain the first bearing 28 in the bearing housing 35.

The first brush support 26 may for example include a plurality of stop members 36, such as stop ribs, distributed about the central axis of the first brush support 26 and extending circumferentially. Each stop member 36 partially delimits the bearing housing 35 and is provided with an axial stop surface against which the first bearing 28 abuts when the first bearing 28 is housed in the bearing housing 35.

As shown in FIG. 6, the motor compartment 19 is fastened to the bearing support 31, and the first bearing 28 is clamped axially between a first stop surface provided on the bearing support 31 and a second stop surface provided on the motor compartment 19.

According to the embodiment represented in the figures, the motor compartment 19 includes a motor cover 37 extending about the drive motor 17 and a cover support 38 fastened to the bearing support 31 and configured to support the motor cover 37. The motor cover 37 more particularly includes a tubular wall 37.1 which extends about the drive motor 17 and which is substantially coaxial with the motor axis of the drive motor 17, and an end wall 37.2 located opposite the cover support 38 and provided with a central opening through which the output shaft 18 of the drive motor 17 projects. The motor cover 37 further includes an open end which is at least partially closed by the cover support 38. Advantageously, the suction head 2 includes a damping element 39 interposed axially between the drive motor 17 and the cover support 38.

The suction head 2 further includes an air-cooling circuit 41 delimited at least partially by the bearing support 31, the drive motor 17, the motor compartment 19, the brush body 12 and the first brush support 26. The suction head 2 is configured so that, when the drive motor 17 is running, a vacuum is generated in the air-cooling circuit 41 and air is sucked up into the air-cooling circuit 41 from the outside of the rotating brush 11 and is circulated in the air-cooling circuit 41, in order to ensure cooling in particular of the drive motor 17 and the first bearing 28.

The air-cooling circuit 41 includes at least one air intake opening 42 through which air is capable of being sucked up into the air-cooling circuit 41. Advantageously, the air intake opening(s) 42 is (are) provided on a lateral wall of the main body 4, and more particularly on the lateral wall of the brush body to which the bearing support 31 is fastened.

The air-cooling circuit 41 further includes a plurality of air discharge openings through which the air flowing into the air-cooling circuit 41 is capable of being discharged out of the air-cooling circuit 41. According to the embodiment represented in the figures, the air discharge openings are formed by through holes 44 provided on the first brush support 26 and configured to fluidly connect the motor housing 21 to the suction chamber 9, and therefore to the suction duct.

As shown in FIG. 8, the through holes 44 are distributed about the central axis of the first brush support 26, and each through hole 44 opens respectively into a first axial face 26.1 of the first brush support 26 which is oriented towards the drive motor 17 and which partially delimits the motor housing 21 and into a second axial face 26.2 of the first brush support 26 which is located outside the brush body 12 and which is oriented towards the lateral wall of the main body 4 to which the bearing support 31 is fastened. Each through hole 44 is more particularly configured to enable the passage of an air stream through said through hole 44 and from the first axial face 26.1 of the first brush support 26 (and therefore from the motor housing 21) towards the second axial face 26.2 of the first brush support 26 (and therefore towards the outside of the rotating brush 11).

According to the embodiment represented in the figures, each through hole 44 provided on the first brush support 26 is delimited by the inner and outer walls 32, 33 of the first brush support 26 and by two stream guide walls 45 which are inclined relative to the central axis of the first brush support 26 and which are located facing each other. Advantageously, the stream guide walls 45 are regularly distributed about the central axis of the first brush support 26, and are configured to mechanically connect the inner and outer walls 32, 33 of the first brush support 26 to each other.

The two stream guide walls 45, which partially delimit a respective through hole 44, are more particularly configured to generate a vacuum within the respective through hole 44 when the drive motor 17 is running and drives in rotation the rotating brush 11 as well as the first brush support 26. Thus, each stream guide wall 45 provided on the first brush support 26 forms a stream guide fin, and the first brush support 26 forms an impeller provided with steam guide fins distributed about the central axis of the first brush support 26. Advantageously, each flow stream fin, and therefore each stream guide wall 45, has an axial dimension and a radial dimension which is smaller than the respective axial dimension. The air-cooling circuit 41 more particularly includes a first circuit portion 41.1 which includes the at least one air intake opening 42 and which is partially delimited by the bearing support 31, the cover support 38, the drive motor 17 and the motor cover 37, and a second circuit portion 41.2 which includes the air discharge openings (formed by the through holes 44), which is partially delimited by the motor compartment 19 and the brush body 12 and which is located downstream of the first circuit portion 41.1.

As shown in FIG. 6, the air-cooling circuit 41 is configured so that, when the drive motor 17 is running, the air, circulated in the air-cooling circuit 41, flows into the first circuit portion 41.1 moving away from the first brush support 26 (and therefore towards the closure cap 15), and flows into the second circuit portion 41.2 towards the first brush support 26.

According to the embodiment represented in the figures, the bearing support 31 is hollow and includes an air flow duct 46 which extends substantially coaxially with the first bearing 28 and which partially forms the first circuit portion 41.1. Advantageously, the air flow duct 46 is fluidly connected to the at least one air intake opening 42, and the first bearing 28 extends about the air flow duct 46.

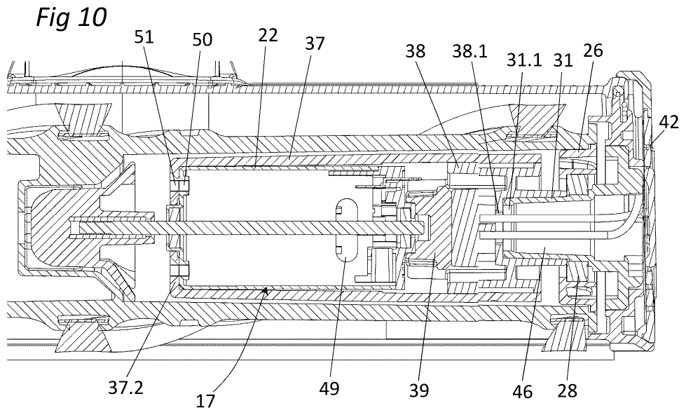

The air flow duct 46 is fluidly connected to an inner housing delimited by the motor compartment 19 (and partially forming the first circuit portion 41.1) via at least one passage orifice 31.1 (see FIG. 10) provided on the bearing support 31 and opening into the air flow duct 46, and at least one air flow passage 38.1 (see FIGS. 6 and 10) provided on the cover support 38 and fluidly liking the at least one passage orifice 31.1 to the inner housing delimited by the motor compartment 19.

Advantageously, the air-cooling circuit 41 is configured so that, when the drive motor 17 is running, the air, circulated in the first circuit portion 41.1, flows at least partially inside the drive motor 17. To this end, the first circuit portion 41.1 includes at least one air inlet opening 49 provided on a peripheral wall of the motor casing 22 and through which the air, circulated in the air-cooling circuit 41 when the drive motor 17 is running, is capable of entering the drive motor 17, and at least one air outlet opening 51 provided on an end wall of the motor casing 22 (which is located opposite the first brush support 26) and through which the air, having entered the drive motor 17 via the at least one air inlet opening 49, is capable of flowing outside the drive motor 17. Advantageously, the at least one air inlet opening 49 is oriented substantially radially and opens into the inner housing delimited by the motor compartment 19, and the at least one air outlet opening 51 is oriented substantially axially.

As shown in FIG. 6, the motor compartment 19 and the brush body 12 delimit a connecting chamber 52 which is located axially opposite the first brush support 26 relative to the drive motor 17 and which is configured to fluidly connect the first circuit portion 41.1 to the second circuit portion 41.2. Advantageously, the at least one air outlet opening 51, provided on the motor casing 22, is fluidly connected to the connecting chamber 52 via at least one connecting orifice 51 (see FIG. 10) provided on the motor cover 37, and more particularly on the end wall 37.2 of the motor cover 37.

According to the embodiment represented in the figures, the air-cooling circuit 41 is configured so that, when the drive motor 17 is running, the air, circulated in the second circuit portion 41.2, flows between an outer surface of the motor compartment 19 and an inner surface of the brush body 12, before reaching the through holes 44 provided on the first brush support 26. Advantageously, the air-cooling circuit 41 is configured so that, when the drive motor 17 is running, the air, circulated in the second circuit portion 41.2, flows substantially parallel to the central longitudinal axis A of the brush body 12.

Cooling of the first bearing 28 and the drive motor 17 via the air-cooling circuit 41 is described below.

Under conditions of use of the suction head 2 according to the present invention, and in particular when the drive motor 17 is running, air is sucked up into the air-cooling circuit 41 via the at least one air intake opening 42 due in particular to the vacuum generated in each of the through holes 44 provided on the first brush support 26. The air, circulated in the air-cooling circuit 41, then flows into the air flow duct 46 where it ensures cooling, by heat conduction, of the bearing support 31 and the inner ring 28.1 of the first bearing 28, then the air flows through the bearing support 31 and the cover support 38 (via the at least one passage orifice and the at least one flow passage), and enters inside the drive motor 17 (via the air inlet opening 49) where it ensures cooling, by heat conduction, of the rotor and/or stator of the drive motor 17. The air is then discharged out of the drive motor 17 via the at least one air outlet opening 51, enters the connecting chamber 52 via the at least one connecting orifice, flows towards the first brush support 26 via the annular longitudinal passage delimited between the motor compartment 19 and the brush body 12, and is discharged out of the rotating brush 11 via the through holes 44 and is sucked up into the suction duct. By flowing through the through holes 44, the air ensures cooling, by heat conduction, of the first brush support 26 and the outer ring 28.2 of the first bearing 28.

As shown in FIG. 9, the inner wall 32 of the first brush support 26 includes a plurality of radial through openings 54 distributed about the central axis of the first brush support 26. Each radial through opening 54 extends in a radial direction and opens into a respective through hole 44 provided on the first brush support 26, and is located facing the first bearing 28, and more particularly facing the outer ring 28.2 of the first bearing 28. Such a configuration of the first brush support 26 allows further promoting the cooling of the first bearing 28 by the air streams flowing through the through holes 44.

Of course, the present invention is in no way limited to the described and illustrated embodiment which has been given only as an example. Modifications are still possible, in particular with regards to the constitution of the various elements or by substitution with technical equivalents, yet without departing from the scope of protection of the invention.

1. A suction head (2) comprising:
a main body (4) including a suction chamber (9) opening into a lower face (6) of the main body (4) which is configured to be oriented towards a surface to be cleaned,
a rotating brush (11) comprising a brush body (12) which has a generally tubular shape and which has a central longitudinal axis (A), the brush body (12) being movably mounted in rotation in the suction chamber (9) about an axis of rotation which is substantially coaxial with the central longitudinal axis (A) of the brush body (12),
a drive device (16) configured to drive in rotation the brush body (12) about the axis of rotation, the drive device (16) including a drive motor (17),
a motor compartment (19) which is fixed relative to the main body (4) and in which the drive motor (17) is at least partially arranged, the motor compartment (19) and the drive motor (17) being at least partially arranged in a motor housing (21) delimited by the brush body (12), and
an air-cooling circuit (41) fluidly connected to the suction chamber (9), the suction head (2) being configured so that, when a vacuum is generated in the suction chamber (9), air is sucked up into the air-cooling circuit (41) from outside the rotating brush (11) and is circulated in the air-cooling circuit (41),
characterized in that the air-cooling circuit (41) includes a first circuit portion (41.1) which is partially delimited by the drive motor (17) and a second circuit portion (41.2) which is partially delimited by the motor compartment (19) and the brush body (12) and which is located downstream of the first circuit portion (41.1), and in that the air-cooling circuit (41) is configured so that, when a vacuum is generated in the suction chamber (9), the air, circulated in the first circuit portion (41.1), flows at least partially inside the drive motor (17), and so that, the air, circulated in the second circuit portion (41.2), flows at least partially between the motor compartment (19) and the brush body (12).

2. The suction head (2) according to claim 1, wherein the first circuit portion (41.1) includes at least one air inlet opening (49) provided on a peripheral wall of a motor casing (22) of the drive motor (17) and through which the air, circulated in the air-cooling circuit (41) when a vacuum is generated in the suction chamber (9), is capable of entering the drive motor (17), and at least one air outlet opening (51) provided on an end wall of the motor casing (22) and through which the air, having entered the drive motor (17) via the at least one air inlet opening (49), is capable of flowing outside the drive motor (17).

3. The suction head (2) according to claim 2, wherein the at least one air inlet opening (49), provided on the motor casing (22), is oriented substantially radially and the at least one air outlet opening (51), provided on the motor casing (22), is oriented substantially axially.

4. The suction head (2) according to any one of claims 1 to 3, wherein the brush body (12) includes a first end portion (12.1) delimiting the motor housing (21) and a second end portion (12.2) located opposite the first end portion (12.1), and the suction head (2) includes a first brush support (26) fastened to the first end portion (12.1) of the brush body (12) and configured to support said first end portion (12.1) and a second brush support (27) fastened to the second end portion (12.2) of the brush body (12) and configured to support said second end portion (12.2).

5. The suction head (2) according to claim 4, wherein the drive motor (17) is arranged axially between the first and second brush supports (26, 27).

6. The suction head (2) according to claim 4 or 5, wherein the air-cooling circuit (41) is configured so that, when a vacuum is generated in the suction chamber (9), the air, circulated in the air-cooling circuit (41), flows in the first circuit portion (41.1) away from the first brush support (26), and flows in the second circuit portion (41.2) towards the first brush support (26).

7. The suction head (2) according to any one of claims 4 to 6, which includes a first bearing (28) configured to guide in rotation the first brush support (26) and a second bearing (29) configured to guide in rotation the second brush support (27), the first brush support (26) being interposed between the first bearing (28) and an inner circumferential surface of the brush body (12).

8. The suction head (2) according to claim 7, which includes a bearing support (31) which is fixed relative to the main body (4), the first bearing (28) being mounted on the bearing support (31) and supported by the bearing support (31).

9. The suction head (2) according to claim 8, wherein the bearing support (31) delimits an air flow duct (46) which partially forms the first circuit portion (41.1), the bearing (28) extending around the air flow duct (46).

10. The suction head (2) according to any one of claims 4 to 9, wherein the air-cooling circuit (41) is delimited at least partially by the first brush support (26).

11. The suction head (2) according to any one of claims 4 to 10, wherein the first brush support (26) is annular and includes at least one through hole (44) which opens respectively into a first axial face (26.1) of the first brush support (26) which is oriented towards the drive motor (17) and into a second axial face (26.2) of the first brush support (26) which is opposite the first axial face (26.1), the at least one through hole (44) being fluidly connected to the suction chamber (9) and the suction head (2) being configured so that, when a vacuum is generated in the suction chamber (9), an air stream flows through the at least one through hole (44) and from the first axial face (26.1) of the first brush support (26) towards the second axial face (26.2) of the first brush support (26).

12. The suction head (2) according to claim 11 in combination with claim 7, wherein the first brush support (26) includes an inner wall (32) which is generally cylindrical and which extends around and in contact with the first bearing (28), the inner wall (32) of the first brush support (26) including at least one radial through opening (54), extending in a radial direction, opening into the at least one through hole (44) provided on the first brush support (26) and being located facing the first bearing (28).

13. The suction head (2) according to claim 11 or 12, wherein the air-cooling circuit (41) includes at least one air discharge opening through which the air flowing into the air-cooling circuit (41) is capable of being discharged out of the air-cooling circuit (41), the at least one air discharge opening being formed by the at least one through hole (44) provided on the first brush support (26).

14. The suction head (2) according to any one of claims 11 to 13, wherein the at least one through hole (44) provided on the first brush support (26) is delimited at least partially by at least one stream guide wall (45) which is inclined relative to a central axis of the first brush support (26) and which is configured to generate a vacuum within the at least one through hole (44) when the drive motor (17) is running.

15. The suction head (2) according to any one of claims 11 to 14, wherein the first brush support (26) forms an impeller provided with stream guide fins distributed about a central axis of the first brush support (26), each pair of adjacent stream guide fins partially delimiting a respective through hole (44).

16. The suction head (2) according to claim 15, wherein each stream guide fin has an axial dimension and a radial dimension which is smaller than the respective axial dimension.

17. The suction head (2) according to any one of claims 1 to 16, wherein the air-cooling circuit (41) includes at least one air intake opening (42) through which air is capable of being sucked up into the air-cooling circuit (41), the at least one air intake opening (42) being provided on a lateral wall of the main body (4).

18. The suction head (2) according to claim 17, wherein the at least one air intake opening (42) is oriented substantially axially.

19. The suction head (2) according to any one of claims 1 to 18, wherein the drive motor (17) is located remotely from the lateral walls of the main body (4).
